(19) United States
(12) Patent Application Publication
(10) Pub. No.: US 2008/0182599 A1
(43) Pub. Date: Jul. 31, 2008

(54) METHOD AND APPARATUS FOR USER INPUT

(75) Inventors: Roope Rainisto, Helsinki (FI); Janne Elsila, Oulu (FI); Martin Schuele, Tampere (FI); Henri Melaanvuo, Karjan (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/669,441

(22) Filed: Jan. 31, 2007

(51) Int. Cl. H04Q 7/20; H04M 1/00

(52) U.S. Cl. 455/466; 455/556.2

(57) ABSTRACT

A method including activating an application, determining if data or at least a portion of a message is present and displaying candidate selections related to the data or at least a portion of the message that are available to the user for selection where the candidate selections supplement a user input related to the data or portion of the message.

### BACKGROUND

1. Field

The disclosed embodiments generally relate to communication devices, and in particular to a user interface for a communication device.

2. Brief Description of Related Developments

Many electronic devices allow a user to input, for example, text into the device for sending messages, making notes, creating documents or event entries. The user input capabilities of the electronic devices are generally provided with either a hardware implemented interface such as, for example, a keyboard with buttons or keys or by a software implemented interface through the use of, for example, a touch screen of the device.

Input through hardware implemented devices such as keyboards allow a relatively high level of comfort and fast input speeds. However, a large number of input keys or buttons and an extensive amount of mechanics must be provided to the user to allow for easy input of information. For example, number keys, letter keys, punctuation keys, special character keys, etc. should be provided to the user to allow for easy input. However, depending on the user, providing this large array of buttons or keys may result in a significant number of buttons that are rarely used. In addition, when keyboards are used on small devices, the keyboards are made as small as possible in an attempt to provide as many keys to user using the limited amount of space available on the device. The small keys may also prove difficult for a user to operate.

Input through a touch screen is generally performed with a pointing device such as, for example, a stylus or a user's finger. Where a stylus is used the small tip of the stylus enables a greater number of software implemented menu items in the form of buttons or elements to be displayed on the screen for selection by the user. However, the small size of these soft keys can prohibit the user from using a finger to activate or select the soft key. Mechanical buttons are not needed when inputting information through a touch screen, which allows the soft keys or input elements to be adapted to the current language, input context, etc. However, input using the touch screen is slower and more cumbersome to the user than inputting information through a keyboard. For example, the stylus may require the user to take out the stylus and place it back in its storage location after each use. The stylus also occupies one hand of the user where a user generally holds the device in one hand while inputting information with the stylus in the other making it hard for the user to use the hand not holding the device for something else. This mode of input also does not allow a user to use both hands for inputting information. Generally, where software and hardware input methods exist in a device the user of the device can choose whether the stylus and touch screen are to be used as an input method or whether the keyboard is to be used as the input method but the user cannot use both concurrently for inputting, for example, text.

Other devices include both hardware and software implemented user interfaces however, the software and hardware user interfaces are generally not used in conjunction with each other when inputting text. For example, menu items are generally presented on a screen of the device and may be accessed through a touch screen implementation or through soft keys of the device. However, the soft keys generally do not allow a user to input, for example, text in combination with a keyboard of the device. In other attempts to aid the user with textual input, text prediction software is used to try and predict a word the user is inputting. However, the wrong words can be presented to the user such that almost every character of the word needs to be entered before the correct word is predicted by the text prediction software.

It would be advantageous to have a user interface that combines features of both hardware and software implemented input methods to provide quick and easy input of information.

### SUMMARY

In one aspect, the disclosed embodiments are directed to a method that includes activating an application, determining if data or at least a portion of a message is present and displaying candidate selections related to the data or at least a portion of the message that are available to the user for selection where the candidate selections supplement a user input related to the data or portion of the message.

In another aspect, the disclosed embodiments are directed to an apparatus that includes a first input, a display, a second input and a processor connected to the first and second input and the display, the processor is configured to cause a presentation of candidate selections on the display in response to a user input through the second input, wherein information is entered with the second input in conjunction with selecting the candidate selections through the first input so that the candidate selections supplement the user input.

In another aspect, the disclosed embodiments are directed to a computer program product. In one embodiment the computer program product includes a computer useable medium having computer readable code means embodied therein for causing a computer to display candidate selections related to the data or at least a portion of the message that are available to the user for selection. The computer readable code means in the computer program product includes computer readable program code means for causing a computer to activate an application, computer readable program code means for causing a computer to determining if data or at least a portion of a message is present and computer readable program code means for causing a computer to displaying candidate selections related to the data or at least a portion of the message that are available to the user for selection where the candidate selections supplement a user input related to the data or portion of the message.

### BRIEF DESCRIPTION OF THE DRAWINGS

The foregoing aspects and other features of the embodiments are explained in the following description, taken in connection with the accompanying drawings, wherein:

FIG. 1 shows a schematic illustration of an apparatus, as an example of an environment in which aspects of the embodiments may be applied;

FIG. 2 illustrates a flow diagram in accordance with aspects of an embodiment;

FIG. 3 illustrates a device in accordance with an embodiment;

FIG. 4-7 show screen shots in accordance with aspects of the embodiments;

FIG. 8 illustrates a device in accordance with an embodiment;

FIG. 9 illustrates a device in accordance with an embodiment;

FIG. 10 is a block diagram illustrating the general architecture of the exemplary device in which aspects of the disclosed embodiments may be implemented;

FIG. 11 is a schematic illustration of a cellular telecommunications system, as an example, of an environment in which a communications device incorporating features of the embodiments may be applied; and

FIG. 12 illustrates a block diagram of one embodiment of a typical apparatus incorporating features that may be used to practice aspects of the invention.

### DETAILED DESCRIPTION OF THE EMBODIMENT(S)

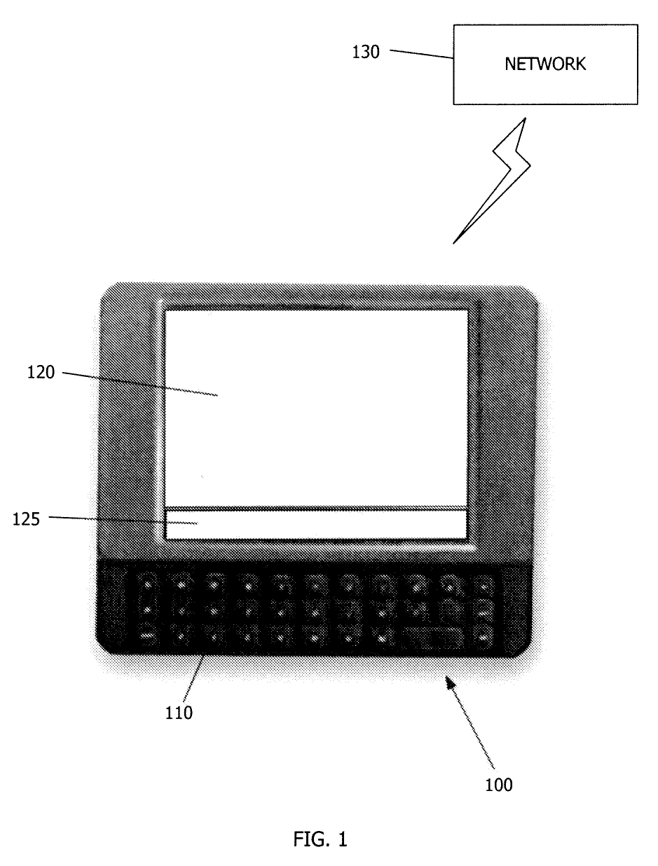

Referring to FIG. 1, one embodiment of a device 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user to quickly and easily enter information into a device 100. The device 100 has a user interface that includes at least a keyboard 110 and a display 120. The display 120 can comprise or include a touch screen that can be used to select or input information. The touch screen may be incorporated as part of the display 120 or can be provided as a separate user interface screen or area 125. Generally a user of the device inputs information such as, for example text, using the keyboard 110 of the device. In accordance with the disclosed embodiments, menu selection items or candidates pertaining to, for example, functions of the device 100 or character inputs can be presented to the user for selection using the touch screen to provide the user with an enhanced input experience. The candidates presented to the user through the display may include any items such as, for example, individual characters, character strings (including but not limited to words, phrases, sentences, abbreviations, etc.), images, avatars, animations or any other suitable information (collectively referred to herein as “characters”) that the user is likely to use in conjunction with inputting information into the device 100. The candidates can be used to supplement information that the user is inputting through the keyboard and provide a more efficient and expedient manner in which to input the information. These candidates will generally be referred to herein as the “supplemental selections” for the hardware keyboard input. The supplemental selections may be context sensitive and depend on, for example, the context or current task and application of the device 100 as well as what the user has previously inputted into the device 100. The supplemental selections can be used to provide input selections that are based on the prediction of possible future input (e.g. text prediction, error corrections, and the like as will be described in greater detail below) to assist the user with inputting information in an efficient and accurate manner.

The exemplary device 100 shown in FIG. 1 includes a keyboard 110, a display 120 and a touch enabled screen 125. Here the touch enabled screen 125 is shown along the bottom portion of the display 120, but in other embodiments the touch enabled screen 125 can comprise any suitable configuration on the device 100. For example, the touch enabled screen 125 may surround the display 120. In other embodiments, the entire display 120 may be touch enabled. The device 100 may be any suitable device including, but not limited to, mobile communication devices, personal digital assistants (PDAs), tablet computers, desktop or laptop computers and the like. The keyboard 110 may be any suitable keyboard such as, for example, a QWERTY or T9 keyboard, that includes any suitable number of keys. The keys may be numeric keys, alphabetic keys, alphanumeric keys, special character keys or any other suitable keys. The display, touch screen and the keyboard may be incorporated into the device 100 as shown in FIG. 1. In other embodiments the display and/or keyboard may be peripheral devices connected in any suitable manner to the device 100. In other embodiments a peripheral keyboard may have a suitable touch enabled display incorporated into the keyboard for implementing aspects of the disclosed embodiments.

The device 100 may be configured to access a network 130 as will be described in greater detail below. The network may be, for example a wide area network, a local area network, a cellular network, the World Wide Web or internet. The device may be further configured to communicate with other devices such as, mobile communication devices (e.g. cellular phones, PDAs, etc.) or stationary devices (e.g. landline phones, desktop computers, etc.) as will also be described in greater detail below.

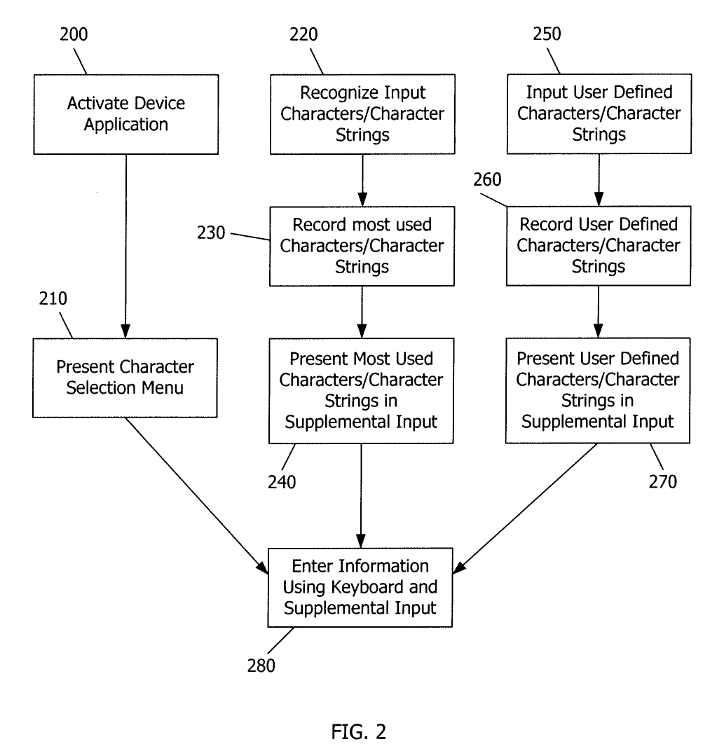

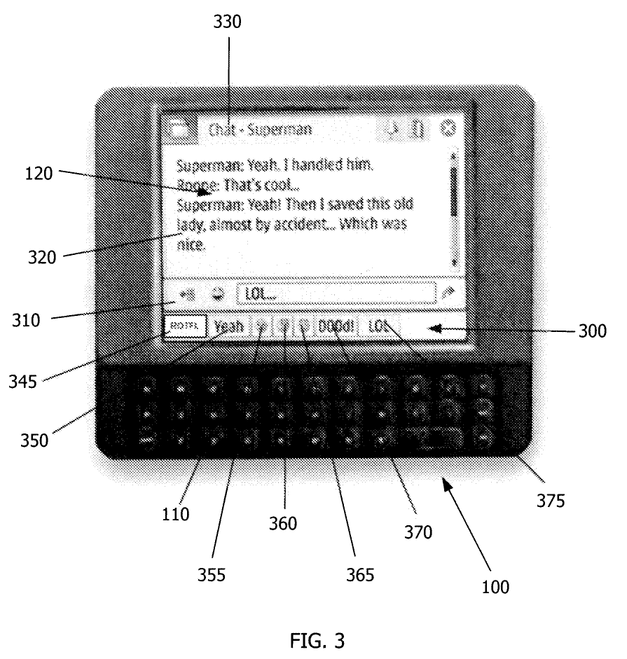

Referring now to FIGS. 2 and 3, in accordance with an embodiment, the user of the device 100 activates a device application (FIG. 2, Block 200). Device applications can include any one of a number of applications including, but not limited to, communication applications, calendar applications, notebook applications, word processing or spreadsheet applications, calculators, web browsers and the like. Communication applications might include application(s) for sending messages, such as for example, multimedia message service messages, short message service messages and email messages. As can be seen in FIG. 3, when, for example, the chat application is activated the display 120 is segmented into a number of sections or areas. Each area can be used to display different information or provide access to various functions of the device or application. In one embodiment, a candidate selection menu 300 is presented and includes the supplemental selection areas 345-375 (FIG. 2, Block 210). The number of candidate selection areas can be any suitable number and is only limited by the area of the display and number of selection areas desired. It is noted that in the embodiments described herein the candidate selection menu 300 is presented on the touch enabled portion of the display 120. In other embodiments where the device includes a touch screen 125 separate from the display 120 as shown for example in FIG. 1, the candidate selection menu 300 may be presented on a portion of the display 120 adjacent to the touch screen 125. Candidate options can be selected by touching a portion of a touch enabled screen 125 that corresponds to a respective character selection area. In other embodiments, the candidate selection menu 300 may be presented on a second touch enabled display that is separate from the display 120.

In the example shown in FIG. 3, the display 120 includes an information bar 330, an application area 320, an input display area 310 and the candidate selection menu 300. In alternate embodiments the display 120 may be divided into any suitable number of portions that include any suitable information or allow user input.

In this example, the information bar 330 includes indicators that can identify the type of application (e.g. in this example it is a chat application), an alert status (e.g. ring tone and the like) of the device 100, a battery life of the device 100 and an option to close the chat application. The application area 320 of the display 120 is generally used to present the main functionality of the application, and may allow the user of the device 100 to view, for example, chat room communications, web pages, calendar entries or any other suitable information. In this example, the application area includes the thread or discussion contents of the chat participants. The input display area 310 of the display 120 may allow the user to see, for example, characters, character strings, symbols, icons or avatars the user inputs into the device 100 before they are placed in the application area 320. In alternate embodiments, the text may be inputted directly into the application area 320. The input display area 310 may also provide the user with editing or navigation options such as spell check, cut, paste, next page, back, home, etc. As noted above, the candidate selection menu 300 of the display 120 includes supplemental selections that might be presented to the user during operation of the device.

In this example the application area 320 is located towards the top of the screen 120. The input display area 310 is located below the application area 320. The candidate selection menu 300 is located below the input display area 310 or closest to the keyboard 110. It is noted that the placement of the different portions 300, 310, 320 is merely exemplary and the different portions may be presented in any suitable locations of the display 120. In this example the candidate selection menu 300 is shown as a “panel” (e.g. a rectangular area) on the display 120. In alternate embodiments the candidate selection menu 300 may take any suitable form on the display 120. The candidate selection menu 300 is located proximate the keyboard 110 in this example to allow the user to access the supplemental selection areas 345-375 with the user's fingers without having to excessively re-posture the user's hands while the user is concurrently operating the keyboard 110.

The candidate selection menu 300 is generally configured to present to the user any suitable candidates. For example, the candidate selection menu 300 may be configured so that the most used candidates are presented in an area configured, for example, as buttons that are suitably sized for selection by a user's finger or other touch screen input device. In other embodiments the characters may be presented in areas configured in any suitable manner. There may be a settings menu in the device 100 that allows the user to select or set the number of candidate areas that are presented in the candidate selection menu. For example, in FIG. 3 there are seven selection areas 345-375 shown in the candidate selection menu. More or fewer areas may be presented depending on the setting specified by the user. As can be seen in FIG. 3, the candidate selection menu 300 includes areas 345-375 corresponding to the characters “ROTFL”, “Yeah”, “ [symbol] ”, a representation of a flirting smiley, a representation of a surprised smiley, “DOOd!” and “LOL”. The characters in the areas 345-375 may represent the most used characters for the chat application, user defined characters or a combination of the most used characters and user defined characters. In this example, in response to the last thread posting by “Superman” the user would like to indicate he is laughing out loud. Rather than manually pressing each key for the sequence “L-O-L” the user selects the area 375 corresponding to the abbreviation “LOL” and that character string is automatically inserted into the reply message in a suitable or selected position.

In other embodiments, the size of the areas 345-375 may automatically change depending on the number of candidate selections that are presented to the user. The user may be able to specify a size of each of the areas (e.g. width and height) so that as candidate selections are added to the candidate selection menu 300 the size of each individual button does not become smaller than the specified size.

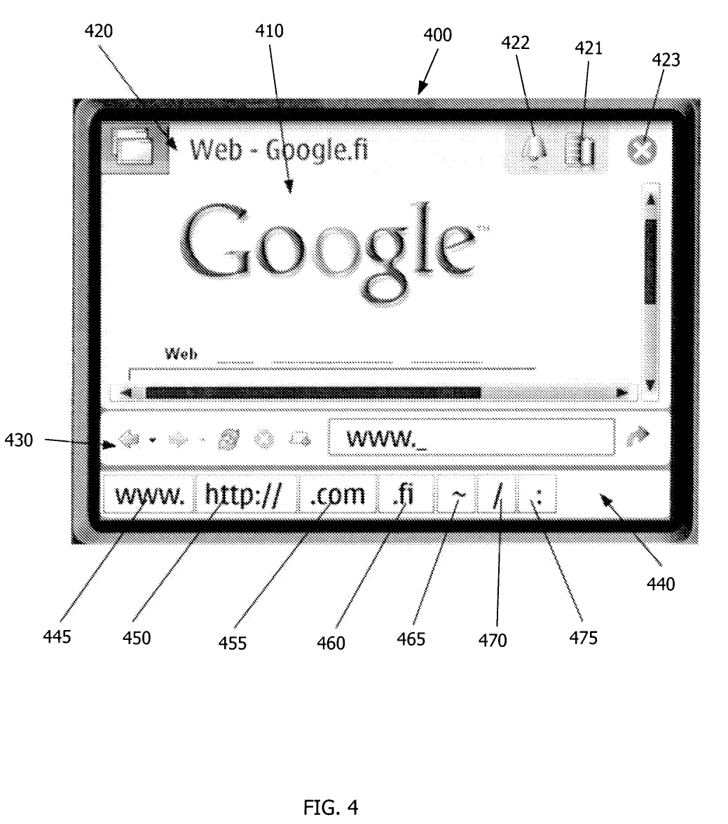

The characters presented in the candidate selection menu 300 are generally intended to allow faster and easier input of information into the device than using just the keyboard. For example, if the “@” symbol is presented in an area in the candidate selection menu 300, it can be faster to select the area corresponding to the “@” symbol than pressing the “shift” and number “2” key on a QWERTY keyboard or trying to access the “@” symbol on a T9 keyboard. In another example, as shown in FIG. 4, the character “www.” is presented in the candidate selection menu. This presentation might be associated with a web browser application or when inputting information related to a web page. The application or device detects text being inputted and predicts that “www.” might be a character string the user will want to use. Thus, a soft key or area for selecting “www.” Is presented. Rather than pressing the “w” key three times and the “.” key once the user can select the button 445 corresponding to the character “www.” for quick input of this character string into the message or other text of a document.

The information presented in the candidate selection menu 300 may be context sensitive. For example, when the user is sending an email the most frequently used candidates for emailing can be available for presentation to and for selection by the user. For example, when the user opens the email application some frequently used characters can be presented. As the user starts to interact with the application by, for example, typing a message, the device can try to predict what characters, strings, or images might be used, and display those in the selection menu. Alternatively, the device can scan a received message, and present possible or predicted options for any reply. When the user is making notes in, for example a note pad of the device, the most frequently used candidates for making notes made available for presentation and selection by the user. When the user is using a calculator application the most frequently used candidates in the calculator application are made available for presentation and selection by the user. The candidates presented in the candidate selection menu 300 may be different for each of the applications in the device. For example, in a calculator function the candidates “+”, “=”, “−” and “/” may be examples of some of the most frequently used characters. In a web browsing application the candidates “www.”, “.com” and “.org” may be examples of some of the most frequently used and in an email application the candidates “!”, “?”, “ [symbol] ”, “ [symbol] ” and “$” may be examples of some of the most frequently used. In other embodiments, the candidates in the candidate selection menu may change upon the detection of a predetermined condition. For example, when the user is typing a note in a notes application and enters the character string “http://” the device 100 may recognize this string of characters and present candidates pertaining to the world wide web (e.g. “www.”, “.com”, etc.) in the candidate selection menu 300. The device 100 may return to the most frequently used candidates for the notes application after a determination that the user is no longer inputting information pertaining to the world wide web.

In one embodiment, the device may be configured to automatically learn which candidates are the most frequently used for a respective application. For example, the device can recognize which characters are used, and the frequency of the user in conjunction with an application (FIG. 2, Block 220). A record or log may be kept indicating the frequency of use of the characters. In alternate embodiments, any suitable software or hardware implemented component of the device 100 may be utilized to recognize the characters. A processor in the device or a character tracking component, for example, may keep track of which characters are entered most often and record those characters in a memory of the device 100 (FIG. 2, Block 230). For example, the character tracking component may recognize that the characters “!”, “?”, “ [symbol] ”, “ [symbol] ” and “$” are the most frequently used characters in an email application and record the same as candidates in a memory so that when the email application is activated by the user of the device 100, the most frequently used candidates are made available in the candidate selection menu 300 for presentation and for selection by the user (FIG. 2, Block 240). The candidates included in the candidate selection menu 300 may change or be updated depending on changes in the user's frequency of use for each of the most used candidates. For example, in the email application the user stops using the candidate “$” and starts using the candidate “ROTFL” (i.e. “rolling on the floor laughing”) an increasing amount. The device 100 may “learn” that the candidate “ROTFL” is being used more than the candidate “$” and may replace the “$” in the candidate selection menu 300 with the candidate “ROTFL”.

In other embodiments, the user may customize the candidate selection menu 300 by defining the candidates that are to be included in the candidate selection menu 300 (FIG. 2, Block 250). For example, the user may define the character “LOL” (i.e. “laughing out loud”) as one of the candidate selections to appear in the candidate selection menu 300 for the email application. The device may record the character “LOL” as a user defined candidate of the email application (FIG. 2, Block 260) and present the candidate “LOL” in the candidate selection menu 300 when the email application is activated by the user or when the device detects an input and predicts that a response might include “LOL” (FIG. 2, Block 270). The user defined candidates may allow the user to choose which candidates (e.g. individual characters, acronyms, abbreviations, images, animations, symbols, etc.) are shown in the candidate selection menu 300 for any suitable reason. For example, an abbreviation that the user rarely uses may be difficult to type so the user may define the abbreviation as a candidate to be displayed in the candidate selection menu 300. In one embodiment, the user defined candidates can take priority over the automatically learned candidates where there is insufficient space to display both the user defined and automatically learned candidates. In alternate embodiments there may be a suitable settings menu in the device that allows the user to specify which candidates are to be presented for selection. For example, the user may configure the device 100 so that only the user defined candidates are made available to be presented, that only the automatically learned candidates are made available to be presented or that a combination of the automatically learned and user defined candidates are made available to be presented. The user may access candidates that are not displayed on the display 120 because of, for example, insufficient space on the display 120 in any suitable manner including, but not limited to, using a scroll key of the device. In one embodiment, the device can present rows of candidate selection areas, where as a scroll option of the device is used, a new row of candidate selection areas appears. Also, the user may be able to scroll left or right on a candidate selection menu to display additional candidate selection areas.

The candidate selection menu 300 and the keyboard 110 may be configured to work synchronously with each other to allow the user of the device to utilize both the keyboard 110 and the candidate selection menu 300 in conjunction with each other to quickly and easily enter information into the device 100.

Referring now to FIG. 4, a screen shot 400 of a web browser application is shown in accordance with an embodiment. In this example, the display may include an information bar 420, a web browser application area 410, an address bar 430 and the candidate selection menu 440. The information bar 420 and application area 410 may be substantially similar to that described above with respect to FIG. 3. The address bar 430 may include navigation aids such as “page back”, “page forward”, “refresh”, “stop” and “favorites” buttons as well as an input display area for inputting a web page address. In this example, the candidate selection menu 440 includes areas 445-475 corresponding to the candidates “www.”, “http://”, “.com”, “.fi”, “˜”, “/” and “:”. As an example of entering a web address, rather than pressing the “w” key of the QWERTY keyboard three times and the “.” key once (or if the user is using a T9 keyboard the “9” key is pressed three times and then the “.” is searched for by, for example, navigating a menu listing) the user presses the area 445 so that the candidate “www.” is entered into the address bar of the web browser. The user can then finish entering the body of the web page address (i.e. the name of the web page) through the keyboard 110 and may enter the domain name by pressing either of the areas 455 or 460 if the “.com” or “.fi” domain names are appropriate.

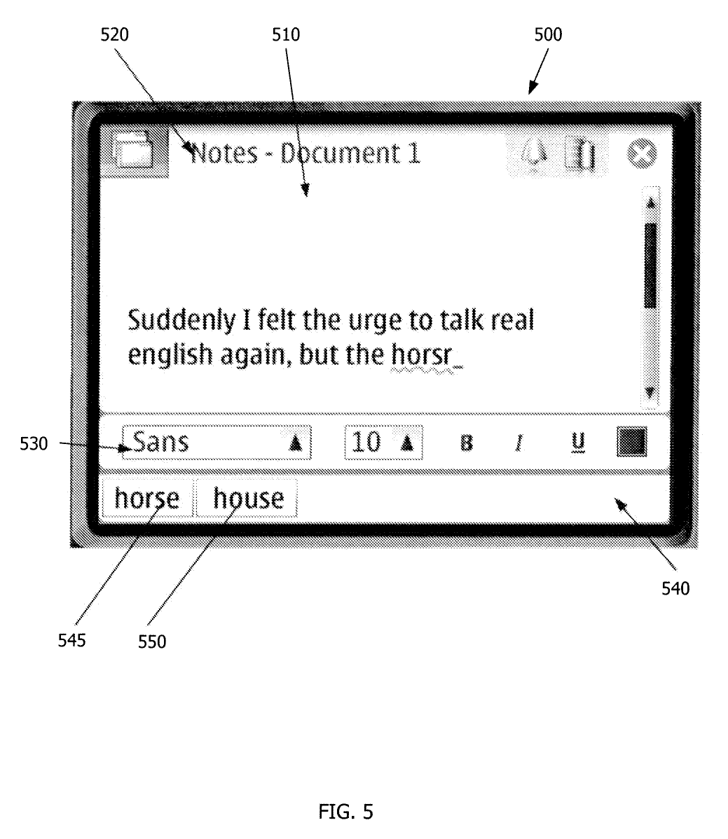

Referring to FIGS. 5-7, the candidate selection menu may also be utilized in conjunction with spell checking, error correction or text prediction applications. The device may include any suitable dictionaries or databases for assisting in correcting misspelled words or predicting the next word in a string of words (e.g. a phrase or sentence) or the next characters in a string of characters (i.e. to complete a word). For example, the device may include any suitable component such as, for example, a text recognition or dictionary component configured to recognize the misspelled characters or a string of characters/words already entered into the device 100. The device may search through a respective one or more of the dictionaries or databases to determine possible words to replace the misspelled word or for words to complete a string of characters (i.e. the word) or a string of previously entered words (i.e. the phrase). The device may cause the words found in the search to be presented to the user as candidates in the candidate selection menu. It is noted that the device may be configured to recognize the use of different languages in, for example, the same note and present search results obtained from dictionaries/databases corresponding to each of the languages used in the note.

An exemplary screen shot 500 representing a notes application of the device 100 is shown in FIG. 5. In this example, a spell check/error correction mode of the device is described. The display may include an information bar 520, a notes application area 510, a toolbar 530 and the candidate selection menu 540. The information bar 520 and application area 510 may be substantially similar to that described above with respect to FIGS. 3 and 4. The toolbar 530 may allow the user to select a type and size of font as well as the change the attributes of the font (e.g. bold, italics, underline, color, etc). In this example the candidate selection menu 540 may include any suitable number of search results found by the device after searching the respective dictionaries and/or databases. Here the user has entered the text “horsr”. The device has recognized the characters “horsr”, performed the search and caused the results to be presented to the user in the candidate selection menu 540. The results are presented in this example as the areas 545 and 550 but in alternate embodiments the search results may be presented in any suitable manner. Here the user has intended to spell the word “house” which is presented as area 550. The device may be configured so that when user selects the area 550 the characters “horsr” are replaced by the word “horse” in the notes application area. It is noted that the device 100 may be configured to indicate a potential error in the body of the note such as for example a misspelled word. As can be seen in FIG. 5, the characters “horsr” are underlined to indicate the spelling error. In other embodiments the device may be configured to identify and present potential errors to the user in any suitable manner.

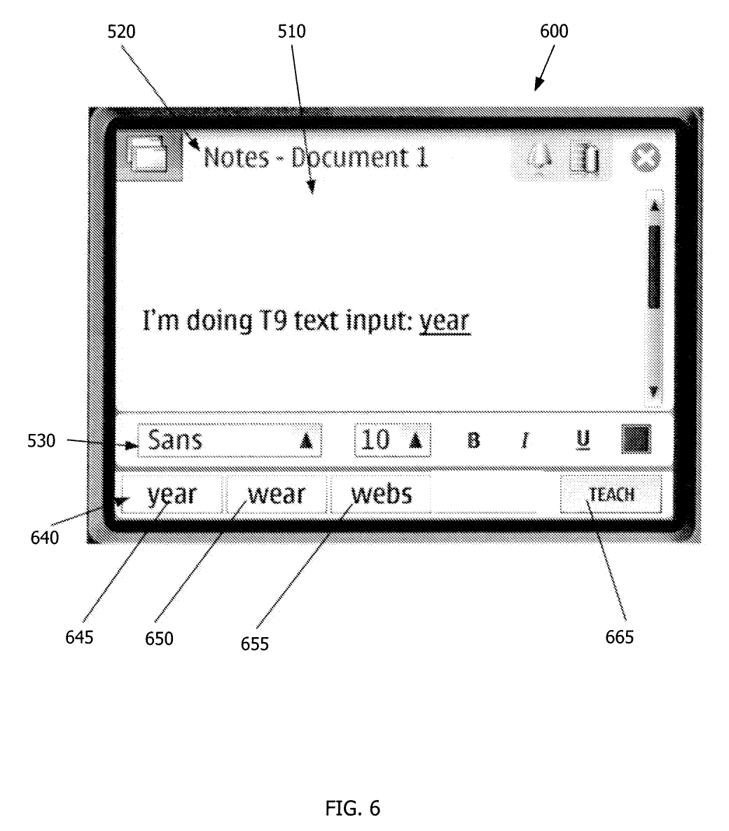

Referring now to FIG. 6, another screen shot 600 representing a notes application of the device 100 is shown. In this example, a text prediction mode of the device is described. This example will be described with respect to the use of a T9 keyboard but it is understood that the text prediction capabilities described herein can be applied with any suitable keyboards including but not limited to QWERTY keyboards. Here the user has intended to enter the word “year”. The device has recognized the input keys activated by the user and their corresponding characters. In this example, the device may have recognized all or some of the keys “9”, “3”, “2” and “7” pressed by the user. In this example, the “9” key corresponds to the letters “WXYZ”, the “3” key corresponds to the letters “DEF”, the “2” key corresponds to the letters “ABC and the “7” key corresponds to the letters “PQRS”. The device performs a search of the dictionaries and/or databases for words corresponding to the letters of the keys pressed by the user and causes the results to be presented as candidates in the candidate selection menu 640 as areas 645-655. The search results may represent the user's original input, a predicted word, alternate words using the characters assigned to a respective key or a combination of predicted words or alternate words. Here the user has intended to spell the word “year” (e.g. the “original input”) which is presented as area 645. The device has also caused alternate words “wear” and “webs” to be presented as areas 650 and 655. The device may be configured so that when user selects the area 645 the word “year” is completed or inserted into the notes application area 510. In this example a “teach” button 665 is presented to a user which may allow the user to teach or add a user defined word into the device so that the user defined word is stored in a suitable memory/database of the device as a candidate. There may also be a suitable settings menu so that the user may select whether the search results are to include predicted words, alternate words or a combination of both.

It is noted that in the case of the presentation of alternate words in the candidate selection menu 640, the alternate words may or may not appear in the notes application area 510 before the user selects the alternate word from the search results. For example, the device 100 may recognize the string of keys pressed by the user, search the dictionaries/databases and present the words which can be formed from the sequence of pressed keys as candidates for selection by the user. This may save the user time in that the user only has to hit each key corresponding to a letter of the word only once rather than having to, for example, press the “9” key three times to get to the letter “y” and so on.

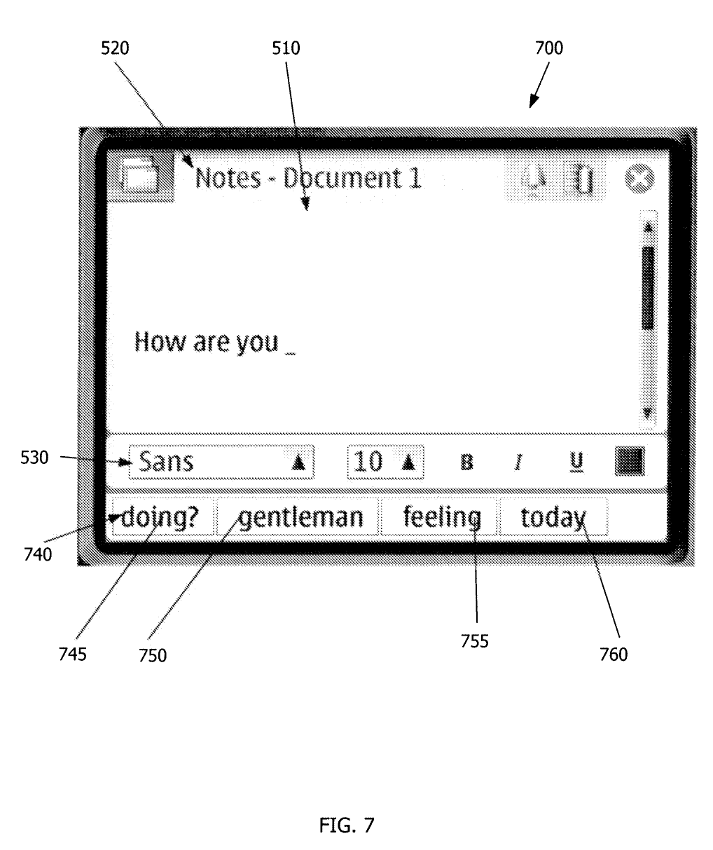

Referring now to FIG. 7, another screen shot 800 representing a notes application of the device 100 is shown. In this example, a word prediction mode of the device is described. In this example Here the user has entered the character string “How are you”. The device recognizes the input character string and performs a search of the dictionaries and/or databases for phrases, sentences and the like corresponding to the character string and causes the results to be presented to the user in the candidate selection menu 740 as the areas 745-760. In this example the search results may represent a predicted word that may complete the input character string “How are you”. If one of the predicted words is acceptable to the user the user may select the area 745-760 corresponding to the predicted word so that the predicted word is entered into the application area 510 to complete, for example, the sentence. If the predicted words are not acceptable the user may use, for example, the keyboard 110 to enter any other suitable word.

The device may have any suitable settings menu to allow the user to select which mode or function the device is to operate (e.g. spell check, text/word prediction, most commonly used candidates, etc.). It is also noted that the different modes of the device may be used individually or in combination. For example, the word prediction and spell check modes may be used at the same time. In other embodiments there may be, for example, a toggle key provided on the device that allows the user to switch between the different modes of the device without having to navigate through a menu. In other embodiments the mode of the device may be dependent on the application. For example in a word processing application, such as the notes application, the device may default to the one or more of the spell check, text/word prediction modes while in a text messaging application the device may default to a most used candidate mode corresponding to the application.

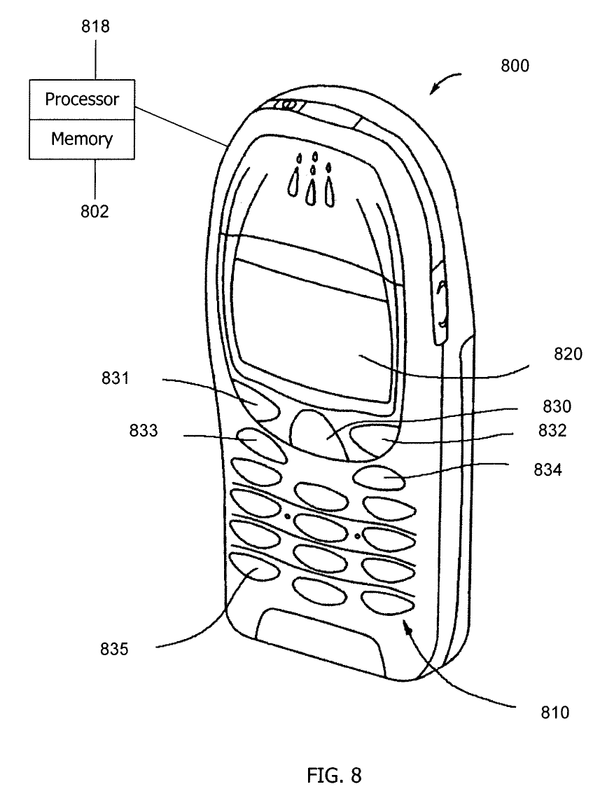

One embodiment of a device 100 in which aspects of the disclosed embodiments may be employed is illustrated in greater detail in FIG. 8. The device may be any suitable device such as terminal or mobile communications device 800. The terminal 800 may have a keypad 810 and a display 820. The keypad 810 may include any suitable user input devices such as, for example, a multi-function/scroll key 830, soft keys 831, 832, a call key 833 and end call key 834 and alphanumeric keys 835. The display 820 may be any suitable display, such as for example, a touch screen display or graphical user interface. The display may be integral to the device 800 or the display may be a peripheral display connected to the device 800. A pointing device, such as for example, a stylus, pen or simply the user's finger may be used with the display 820. In alternate embodiments any suitable pointing device may be used. In other alternate embodiments, the display may be a conventional display. The device 800 may also include other suitable features such as, for example, a camera, loud speaker, connectivity port or tactile feedback features. The mobile communications device may have a processor 818 connected to the display for processing user inputs and displaying information on the display 820. A memory 802 may be connected to the processor 818 for storing any suitable information and/or applications associated with the mobile communications device 800 such as word processors, phone book entries, calendar entries, web browser, etc.

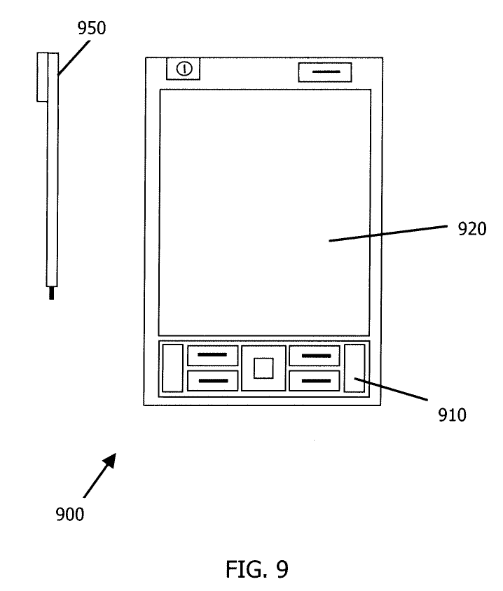

In one embodiment, the device 100, may be for example, a PDA style device 900 illustrated in FIG. 9. The PDA 900 may have a keypad 910, a touch screen display 920 and a pointing device 950 for use on the touch screen display 920. In still other alternate embodiments, the device may be a personal communicator, a tablet computer, a laptop or desktop computer, a television or television set top box or any other suitable device capable of containing the display 920 and supported electronics such as the processor 818 and memory 802.

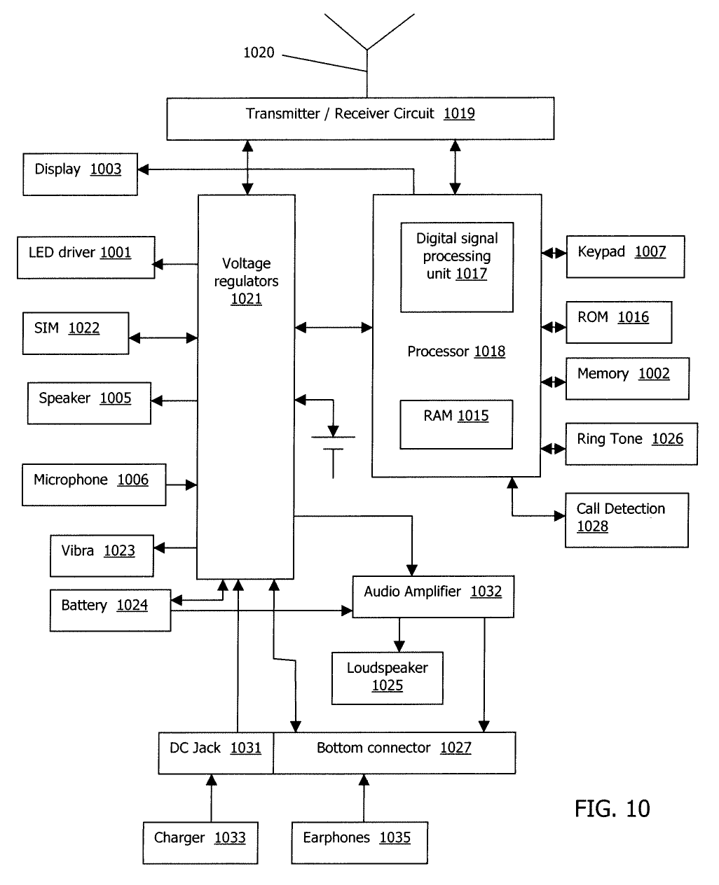

FIG. 10 illustrates in block diagram form one embodiment of a general architecture of a mobile device in which aspects of the embodiments may be employed. The mobile communications device may have a processor 1018 connected to the display 1003 for processing user inputs and displaying information on the display 1003. The processor 1018 controls the operation of the device and can have an integrated digital signal processor 1017 and an integrated RAM 1015. The processor 1018 controls the communication with a cellular network via a transmitter/receiver circuit 1019 and an antenna 1020. A microphone 1006 is coupled to the processor 1018 via voltage regulators 1021 that transform the user's speech into analog signals. The analog signals formed are A/D converted in an A/D converter (not shown) before the speech is encoded in the DSP 1017 that is included in the processor 1018. The encoded speech signal is transferred to the processor 1018, which e.g. supports, for example, the GSM terminal software. The digital signal-processing unit 1017 speech-decodes the signal, which is transferred from the processor 1018 to the speaker 1005 via a D/A converter (not shown).

The voltage regulators 1021 form the interface for the speaker 1005, the microphone 1006, the LED drivers 1001 (for the LEDS backlighting the keypad 1007 and the display 1003), the SIM card 1022, battery 1024, the bottom connector 1027, the DC jack 1031 (for connecting to the charger 1033) and the audio amplifier 1032 that drives the (hands-free) loudspeaker 1025.

A processor 1018 can also include memory 1002 for storing any suitable information and/or applications associated with the mobile communications device such as, for example, those described herein.

The processor 1018 also forms the interface for peripheral units of the device, such as for example, a (Flash) ROM memory 1016, the graphical display 1003, the keypad 1007, a ringing tone selection unit 1026, an incoming call detection unit 1028. In alternate embodiments, any suitable peripheral units for the device can be included.

The software in the RAM 1015 and/or in the flash ROM 1016 contains instructions for the processor 1018 to perform a plurality of different applications and functions such as, for example, those described herein.

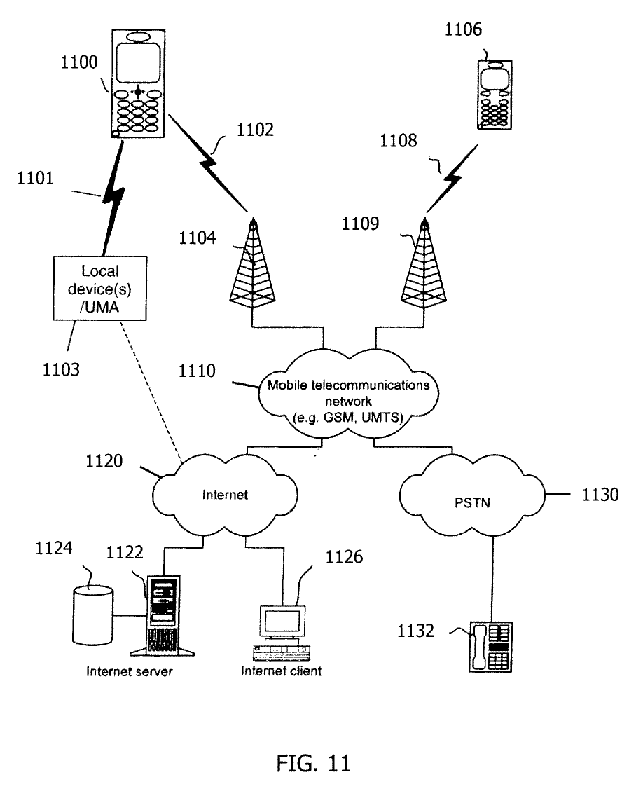

FIG. 11 is a schematic illustration of a cellular telecommunications system, as an example, of an environment in which a communications device 1100 incorporating features of an embodiment may be applied. Communication device 1100 may be substantially similar to that described above with respect to device 100. In the telecommunication system of FIG. 11, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1100 and other devices, such as another mobile terminal 1106, a stationary telephone 1132, or an internet server 1122. It is to be noted that for different embodiments of the mobile terminal 1100 and in different situations, different ones of the telecommunications services referred to above may or may not be available. The aspects of the invention are not limited to any particular set of services in this respect.

The mobile terminals 1100, 1106 may be connected to a mobile telecommunications network 1110 through radio frequency (RF) links 1102, 1108 via base stations 1104, 1109. The mobile telecommunications network 1110 may be in compliance with any commercially available mobile telecommunications standard such as GSM, UMTS, D-AMPS, CDMA2000, FOMA and TD-SCDMA.

The mobile telecommunications network 1110 may be operatively connected to a wide area network 1120, which may be the internet or a part thereof. An internet server 1122 has data storage 1124 and is connected to the wide area network 1120, as is an internet client computer 1126. The server 1122 may host a www/hap server capable of serving www/hap content to the mobile terminal 1100.

For example, a public switched telephone network (PSTN) 1130 may be connected to the mobile telecommunications network 1110 in a familiar manner. Various telephone terminals, including the stationary telephone 1132, may be connected to the PSTN 1130.

The mobile terminal 1100 is also capable of communicating locally via a local link 1101 to one or more local devices 1103. The local link 1101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1103 can, for example, be various sensors that can communicate measurement values to the mobile terminal 1100 over the local link 1101. The above examples are not intended to be limiting, and any suitable type of link may be utilized. The local devices 1103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1100 may thus have multi-radio capability for connecting wirelessly using mobile communications network 1110, WLAN or both. Communication with the mobile telecommunications network 1110 may also be implemented using WiFi, WiMax, or any other suitable protocols, and such communication may utilize unlicensed portions of the radio spectrum (e.g. unlicensed mobile access (UMA)).

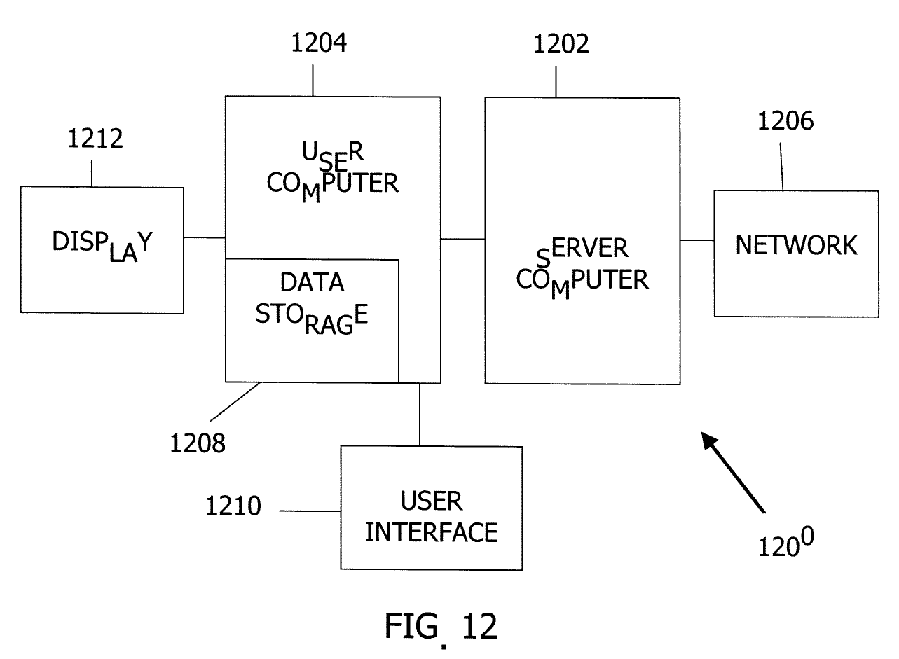

The disclosed embodiments may also include software and computer programs incorporating the process steps and instructions described herein that are executed in different computers. FIG. 12 is a block diagram of one embodiment of a typical apparatus 1200 incorporating features that may be used to practice aspects of the embodiments. As shown, a computer system 1202 may be linked to another computer system 1204, such that the computers 1202 and 1204 are capable of sending information to each other and receiving information from each other. In one embodiment, computer system 1202 could include a server computer adapted to communicate with a network 1206. Computer systems 1202 and 1204 can be linked together in any conventional manner including, for example, a modem, hard wire connection, or fiber optic link. Generally, information can be made available to both computer systems 1202 and 1204 using a communication protocol typically sent over a communication channel or through a dial-up connection on ISDN line. Computers 1202 and 1204 are generally adapted to utilize program storage devices embodying machine readable program source code, which is adapted to cause the computers 1202 and 1204 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1202 and 1204 may also include a microprocessor for executing stored programs. Computer 1202 may include a data storage device 1008 on its program storage device for the storage of information and data. The computer program or software incorporating the processes and method steps incorporating aspects of the invention may be stored in one or more computers 1202 and 1204 on an otherwise conventional program storage device. In one embodiment, computers 1202 and 1204 may include a user interface 1210, and a display interface 1212 from which aspects of the invention can be accessed. The user interface 1210 and the display interface 1212 can be adapted to allow the input of queries and commands to the system, as well as present the results of the commands and queries.

In accordance with the embodiments described herein the candidate selection menu may be provided as a semi-dedicated user interface area of the display. The candidate selection menu may not be displayed when, for example, there are no most frequently used characters, predicted text/words, etc., to present to a user. When the candidate selection menu is displayed the other user interface content (e.g. the application areas, toolbars, etc.) may be automatically resized in any suitable manner so that the candidate selection menu is presented on the display so as not to obstruct the user's view of the other user interface areas.

The disclosed embodiments may allow a user to quickly and easily enter information into an device by implementing both a keyboard of the device in conjunction with a touch enabled screen of the device. Generally a user of the device inputs information such as, for example, text using the keyboard of the device. In accordance with the disclosed embodiments, candidate selection menus or areas are presented to the user, which include characters that can be selected using the touch screen display to provide the user with an enhanced input experience. The candidate selections presented to the user through the touch screen display may contain any suitable information such as individual text characters, text strings, images and the like that supplement whatever information the user is inputting through the keyboard. The candidate selection menu may be a context sensitive area of the display that depends on, for example, the context or current task and application of the device as well as what the user has previously inputted into the device. The candidate selection menu and the candidates included therein may provide and predict possible future input (e.g. text/word prediction, error corrections, and the like) to assist the user with inputting information in an efficient and accurate manner by supplementing the inputting of information through, for example, the keyboard.

The disclosed embodiments incorporate the ability for fast input speeds of the hardware implemented keyboards and the dynamic content of the software implemented inputs (e.g. touch screen display) to allow a user to quickly and easily input information into the device. The full input method does not have to be provided with the candidate selection menu as the candidate selection menu works in conjunction with the hardware implemented inputs to enhance the abilities of the hardware implemented inputs.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A method comprising:
activating an application;
determining if data or at least a portion of a message is present; and
displaying candidate selections related to the data or at least a portion of the message that are available to the user for selection where the candidate selections supplement a user input related to the data or portion of the message.

2. The method of claim 1, wherein the candidate selections are displayed in a candidate selection menu and are selected using a first input and the user input is input using a second input wherein the first and second inputs are used in conjunction with each other so that the first input enhances the ability to enter information with the second input.

3. The method of claim 1, wherein the candidate selections are context sensitive to a current task and application of a device or to information previously input by a user.

4. The method of claim 1, wherein the candidate selections are presented on a touch enabled portion of the display or are presented on the display next to a separate touch enabled screen so that portions of the touch enabled screen correspond to a respective location of one of the supplemental selections.

5. The method of claim 1, wherein the candidate selections include individual characters, character strings, words, phrases, sentences, abbreviations, images, avatars and animations.

6. The method of claim 5, further comprising:
recognizing characters input by a user;
recording characters that are most frequently used by a user as candidates;
and
displaying the candidates that are available for selection by the user in a candidate selection menu.

7. The method of claim 5, further comprising:
recording predefined characters as candidates; and
displaying the candidates that are available for selection by the user in a candidate selection menu.

8. The method of claim 5, further comprising:
recognizing characters input by a user;
searching at least one memory of a device; and
displaying at least one word obtained from the search as a candidate in a candidate selection menu that is available for selection by a user to replace a misspelled word corresponding to the characters or to complete a phrase or sentence corresponding to the characters.

9. The method of claim 8, further comprising indicating to the user a potential error pertaining to words formed by the characters input by the user.

10. The method of claim 1, further comprising presenting the candidate selections on the display so that an original content of the display is not obstructed.

11. The method of claim 10, wherein the original content of the display is automatically resized.

12. The method of claim 1, wherein the candidate selections are not displayed to the user when there are no most frequently used candidates or when results of a search pertaining to information input by a user yields no results.

13. An apparatus comprising:
a first input;
a display;
a second input; and
a processor connected to the first and second input and the display, the processor is configured to cause a presentation of candidate selections on the display in response to a user input through the second input;
wherein information is entered with the second input in conjunction with selecting the candidate selections through the first input so that the candidate selections supplement the user input.

14. The apparatus of claim 13, wherein the candidate selections are context sensitive to a current task and application of a device or to information previously input by a user.

15. The apparatus of claim 13, wherein the first input is a touch enabled screen and the candidate selections are presented on the display next to the touch enabled screen so that portions of the touch enabled screen correspond to a respective location of one of the candidate selections.

16. The apparatus of claim 13, wherein the display comprises the first input in the form of a touch enabled screen.

17. The apparatus of claim 13, wherein the candidate selections include individual characters, character strings, words, phrases, sentences, abbreviations, images, avatars and animations.

18. The apparatus of claim 17, wherein the processor is further configured to recognize characters input by a user, record characters that are most frequently used by a user as candidates and present the candidates available for selection by the user in a candidate selection menu.

19. The apparatus of claim 17, wherein the processor is further configured to record predefined characters as candidates and present the candidates available for selection by the user in a candidate selection menu.

20. The apparatus of claim 17, wherein the processor is further configured to recognize characters input by a user, search at least one memory of the apparatus and provide at least one word obtained from the search as a candidate available for selection by a user in a candidate selection menu to allow the user to replace a misspelled word corresponding to the characters or complete a phrase or sentence corresponding to the characters.

21. The apparatus of claim 13, wherein the apparatus is a mobile communication device.

22. A computer program product comprising:
a computer useable medium having computer readable code means embodied therein for causing a computer to display candidate selections related to the data or at least a portion of the message that are available to the user for selection, the computer readable code means in the computer program product comprising:
computer readable program code means for causing a computer to activate an application;
computer readable program code means for causing a computer to determining if data or at least a portion of a message is present; and
computer readable program code means for causing a computer to displaying candidate selections related to the data or at least a portion of the message that are available to the user for selection where the candidate selections supplement a user input related to the data or portion of the message.

23. The computer program product of claim 22, wherein the candidate selections are context sensitive to a current task and application of a device or to information previously input by a user.

24. The computer program product of claim 22, wherein the character selections include characters, where the characters are individual characters, character strings, words, phrases, sentences, abbreviations, images, avatars and animations.

25. The computer program product of claim 24, further comprising:
computer readable program code means for causing a computer to recognize characters input by a user;
computer readable program code means for causing a computer to record characters that are most frequently used by a user as candidates; and
computer readable program code means for causing a computer to display the candidates that are available for selection by the user in a candidate selection menu.

26. The computer program product of claim 24, further comprising:
computer readable program code means for causing a computer to record predefined characters as candidates; and
computer readable program code means for causing a computer to display the candidates that are available for selection by the user in a candidate selection menu.

27. The computer program product of claim 24, further comprising:
computer readable program code means for causing a computer to recognize characters input by a user;
computer readable program code means for causing a computer to search at least one memory of the computer; and
computer readable program code means for causing a computer to provide at least one word obtained from the search as a candidate in a candidate selection menu that is available for selection by a user to replace a misspelled word corresponding to the characters or to provide at least one word obtained from the search as a candidate that is available for selection by a user to complete a phrase or sentence corresponding to the characters.
